(19) United States
(12) Patent Application Publication
(10) Pub. No.: US 2024/0058983 A1
(43) Pub. Date: Feb. 22, 2024

(54) COMPOUND MITER SAW TABLE

(71) Applicants: JERRY AXLEY, Athens, TN (US); BETTY AXLEY, Athens, TN (US)

(72) Inventors: JERRY AXLEY, Athens, TN (US); BETTY AXLEY, Athens, TN (US)

(21) Appl. No.: 17/700,640

(22) Filed: Mar. 22, 2022

(51) Int. Cl. B27G 19/02; B23D 47/02; B23D 45/04

(52) U.S. Cl. CPC B27G 19/02; B23D 47/02; B23D 45/048; B23D 45/044

(57) ABSTRACT

The compound miter saw table includes a workshop table, a left side wing, and a right side wing. The workshop table is configured to support a saw. As non-limiting examples, the saw is a chop saw or a compound miter saw. The left side wing and the right side wing include articulated extensions that are deployed individually or together in order to support work material while the work material is being cut. The top surface of the workshop table is recessed below the top surfaces of the left side wing and the right side wing such that the work material rests evenly, supported by the saw, the left side wing, the right side wing, or any combination thereof.

### CROSS REFERENCES TO RELATED APPLICATIONS

Not Applicable

### STATEMENT REGARDING FEDERALLY SPONSORED RESEARCH

Not Applicable

### REFERENCE TO APPENDIX

Not Applicable

### BACKGROUND OF THE INVENTION

### Field of the Invention

The present invention relates to the field of woodworking tool accessories, more specifically, a compound miter saw table.

### SUMMARY OF INVENTION

The compound miter saw table comprises a workshop table, a left side wing, and a right side wing. The workshop table may be configured to support a saw. As non-limiting examples, the saw may be a chop saw or a compound miter saw. The left side wing and the right side wing may be articulated extensions that may be deployed individually or together in order to support work material while the work material is being cut. The top surface of the workshop table may be recessed below the top surfaces of the left side wing and the right side wing such that the work material may rest evenly, supported by the saw, the left side wing, the right side wing, or any combination thereof.

An object of the invention is to provide a workshop table that may elevate a saw.

Another object of the invention is to provide a left side wing and a right side wing such that the saw, the left side wing, the right side wing, or any combination thereof may support the work material evenly.

A further object of the invention is to articulate the side wings such that the side wings may fold for storage alongside the workshop table.

Yet another object of the invention is to provide a left offset block and a right offset block on the table top of the workshop table such that the saw sits in a recessed area.

These together with additional objects, features and advantages of the compound miter saw table will be readily apparent to those of ordinary skill in the art upon reading the following detailed description of the presently preferred, but nonetheless illustrative, embodiments when taken in conjunction with the accompanying drawings.

In this respect, before explaining the current embodiments of the compound miter saw table in detail, it is to be understood that the compound miter saw table is not limited in its applications to the details of construction and arrangements of the components set forth in the following description or illustration. Those skilled in the art will appreciate that the concept of this disclosure may be readily utilized as a basis for the design of other structures, methods, and systems for carrying out the several purposes of the compound miter saw table.

It is therefore important that the claims be regarded as including such equivalent construction insofar as they do not depart from the spirit and scope of the compound miter saw table. It is also to be understood that the phraseology and terminology employed herein are for purposes of description and should not be regarded as limiting.

### BRIEF DESCRIPTION OF DRAWINGS

The accompanying drawings, which are included to provide a further understanding of the invention are incorporated in and constitute a part of this specification, illustrate an embodiment of the invention and together with the description serve to explain the principles of the invention. They are meant to be exemplary illustrations provided to enable persons skilled in the art to practice the disclosure and are not intended to limit the scope of the appended claims.

FIG. 1 is an isometric view of an embodiment of the disclosure.

FIG. 2 is a front view of an embodiment of the disclosure.

FIG. 3 is a top view of an embodiment of the disclosure.

FIG. 4 is a detail view of an embodiment of the disclosure illustrating the folding of the left side wing and the right side wing.

### DETAILED DESCRIPTION OF THE EMBODIMENT

The following detailed description is merely exemplary in nature and is not intended to limit the described embodiments of the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the appended claims. Furthermore, there is no intention to be bound by any expressed or implied theory presented in the preceding technical field, background, brief summary or the following detailed description. As used herein, the word “or” is intended to be inclusive.

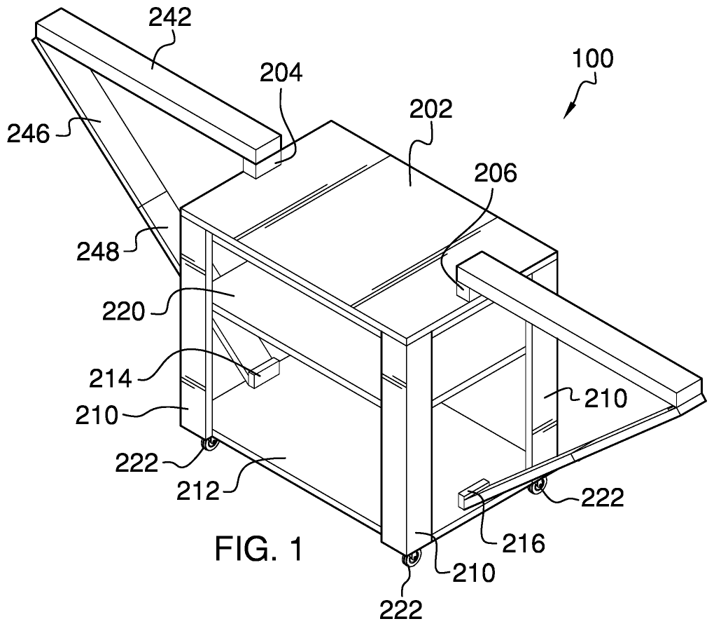

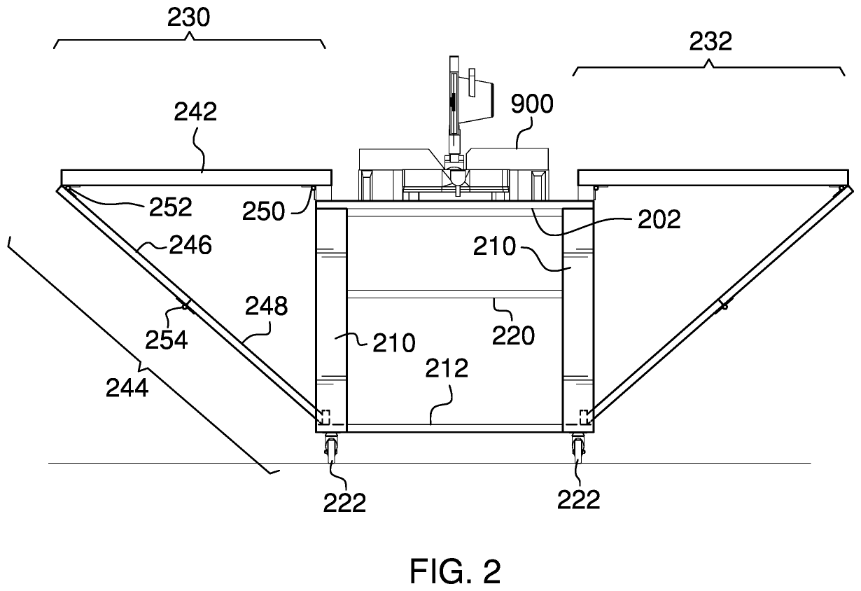

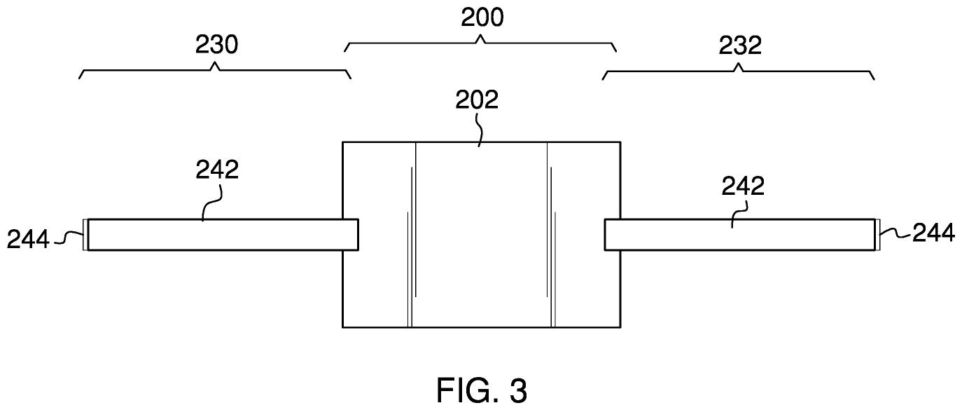

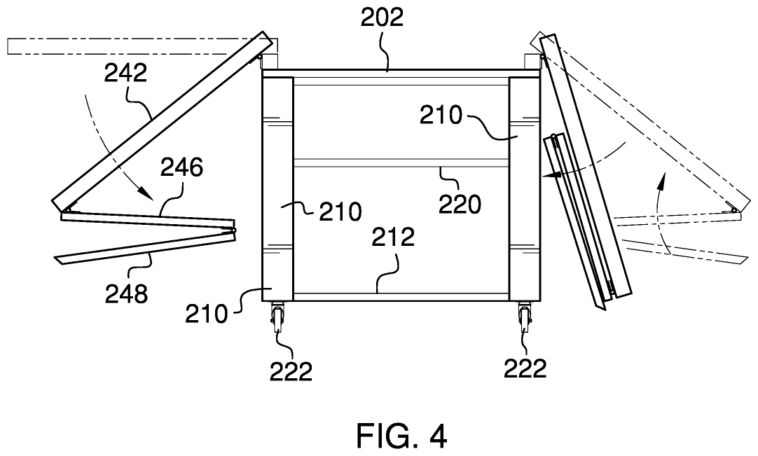

Detailed reference will now be made to a first potential embodiment of the disclosure, which is illustrated in FIGS. 1 through 4.

The compound miter saw table 100 (hereinafter invention) comprises a workshop table 200, a left side wing 230, and a right side wing 232. The workshop table 200 may be configured to support a saw 900. As non-limiting examples, the saw 900 may be a chop saw or a compound miter saw. The left side wing 230 and the right side wing 232 may be articulated extensions that may be deployed individually or together in order to support work material while the work material is being cut. The top surface of the workshop table 200 may be recessed below the top surfaces of the left side wing 230 and the right side wing 232 such that the work material may rest evenly, supported by the saw 900, the left side wing 230, the right side wing 232, or any combination thereof.

The workshop table 200 may comprise a table top 202, a plurality of legs 210, a bottom shelf 212, one or more intermediate shelves 220, and a plurality of wheels 222. The table top 202 may be a horizontal planar surface which may support the saw 900. The table top 202 may comprise a left offset block 204 coupled to the center left side of the top surface of the table top 202 and a right offset block 206 coupled to the center right side of the top surface of the table top 202. The left side wing 230 may hingedly couple to the left offset block 204. The right side wing 232 may hingedly couple to the right offset block 206.

The table top 202 may be supported by the plurality of legs 210. The plurality of legs 210 may be vertically oriented and located at each corner of the workshop table 200. The table top 202 may couple to the tops of the plurality of legs 210. The table top 202 may extend to the outside surfaces of the plurality of legs 210 both laterally and front-to-rear.

The bottom shelf 212 may be a horizontal planar surface coupled to the plurality of legs 210 at the bottom of the workshop table 200. The bottom shelf 212 may provide storage area for tools and/or materials. The bottom shelf 212 may extend laterally to the outside surfaces of the plurality of legs 210.

The bottom shelf 212 may comprise a left stopper block 214 coupled to the center left side of the top surface of the bottom shelf 212 and a right stopper block 216 coupled to the center right side of the top surface of the bottom shelf 212. The left stopper block 214 may retain the bottom end of the left side wing 230 when the left side wing 230 is deployed. The right stopper block 216 may retain the bottom end of the right side wing 232 when the right side wing 232 is deployed.

The one or more intermediate shelves 220 may be horizontal planar surfaces coupled to the plurality of legs 210 at heights between the table top 202 and the bottom shelf 212. The one or more intermediate shelves 220 may provide storage area for tools and/or materials. The one or more intermediate shelves 220 may extend laterally to the inside surfaces of the plurality of legs 210.

The plurality of wheels 222 may reduce friction between the workshop table 200 and the ground such that the workshop table 200 may be moved between job sites. The plurality of wheels 222 may be coupled to the bottom of the workshop table 200. Two or more of the plurality of wheels 222 may swivel to facilitate steering. Two or more of the plurality of wheels 222 may comprise brakes to prevent the workshop table 200 from moving during use.

An individual side wing selected from the left side wing 230 and the right side wing 232 may be an articulated extension that may support the work material when the individual side wing is deployed and may fold against a side of the workshop table 200 when the individual side wing is not deployed. The individual side wing may comprise a horizontal armature 242 and a diagonal armature 244. When the individual side wing is deployed, the horizontal armature 242 may extend horizontally to support the work material and the diagonal armature 244 may brace the horizontal armature 242 against the bottom shelf 212.

The proximal end of the horizontal armature 242 may be hingedly coupled to an individual offset block selected from the left offset block 204 and the right offset block 206. When the individual side wing is deployed, the horizontal armature 242 may cover the top of the individual offset block. The horizontal armature 242 may be coupled to the individual offset block via a first wing hinge 250. The first wing hinge 250 may be positioned where the top outside edge of the individual offset block meets the underside of the horizontal armature 242 such that the horizontal armature 242 may rest on top of the individual offset block when the individual side wing is deployed and may pivot to a position alongside the individual offset block when the individual side wing is not deployed.

The top of the diagonal armature 244 may be hingedly coupled to the distal end of the horizontal armature 242 via a second wing hinge 252. The second wing hinge 252 may be positioned on the underside of the distal end of the horizontal armature 242. The second wing hinge 252 may enable the diagonal armature 244 to pivot to a position that is adjacent to the underside of the horizontal armature 242. When the individual side wing is deployed, the diagonal armature 244 may extend from the distal end of the horizontal armature 242 to an individual stopper block selected from the left stopper block 214 and the right stopper block 216 such that the diagonal armature 244 may support the distal end of the horizontal armature 242 as a brace.

The diagonal armature 244 may comprise an upper diagonal armature 246 and a lower diagonal armature 248. The upper diagonal armature 246 and the lower diagonal armature 248 may be hingedly coupled via a third wing hinge 254 such that the diagonal armature 244 may fold when the individual side wing is not deployed. The third wing hinge 254 may be positioned on the underside of the diagonal armature 244 where the upper diagonal armature 246 and the lower diagonal armature 248 meet. The bottom end of the lower diagonal armature 248 may be mitered to match the angle that the diagonal armature 244 meets the individual stopper block.

The individual side wing may be deployed by pivoting the horizontal armature 242 to a horizontal orientation, unfolding the diagonal armature 244, and positioning the bottom end of the diagonal armature 244 against the individual stopper block. The individual side wing may be stored by folding the diagonal armature 244 at the third wing hinge 254, pivoting the diagonal armature 244 up to a position adjacent to the horizontal armature 242, and pivoting the horizontal armature 242 to a vertical orientation. When the individual side wing is not deployed, the diagonal armature 244 remains folded and may be located in the space between the one or more intermediate shelves 220 and the horizontal armature 242 which is vertically oriented.

In a preferred embodiment, the invention 100 may have a height of 30.0 inches 5.0 inches. The table top 202 may have a side-to-side width of 36.0 inches 3.0 inches and a front-to-rear depth of 24.0 inches 3.0 inches. When both the left side wing 230 and the right side wing 232 are deployed, the invention 100 may have an overall workable width of over 8 feet.

In use, the workshop table 200 may be rolled to a job site and the plurality of wheels 222 may be locked to prevent movement. The left side wing 230, the right side wing 232, or both may be deployed, thus extending the work area laterally to support the work material. An individual side wing may be deployed by pivoting the horizontal armature 242 to a horizontal position, unfolding the diagonal armature 244, and setting the bottom of the diagonal armature 244 against an individual stopper block. The work material may be placed on the saw 900 and may be supported evenly by the left side wing 230, the right side wing 232, the saw 900, or any combination thereof.

### Definitions

Unless otherwise stated, the words “up”, “down”, “top”, “bottom”, “upper”, and “lower” should be interpreted within a gravitational framework. “Down” is the direction that gravity would pull an object. “Up” is the opposite of “down”. “Bottom” is the part of an object that is down farther than any other part of the object. “Top” is the part of an object that is up farther than any other part of the object. “Upper” may refer to top and “lower” may refer to the bottom. As a non-limiting example, the upper end of a vertical shaft is the top end of the vertical shaft.

As used in this disclosure, a “brace” may be a structural element that is used to support or otherwise steady an object.

As used herein, the words “couple”, “couples”, “coupled” or “coupling”, may refer to connecting, either directly or indirectly, and does not necessarily imply a mechanical connection.

As used in this disclosure, the terms “distal” and “proximal” may be used to describe relative positions. Distal refers to the object, or the end of an object, that is situated away from the point of origin, point of reference, or point of attachment. Proximal refers to an object, or end of an object, that is situated towards the point of origin, point of reference, or point of attachment. Distal implies ‘farther away from’ and proximal implies ‘closer to’. In some instances, the point of attachment may be the where an operator or user of the object makes contact with the object. In some instances, the point of origin or point of reference may be a center point, a central axis, or a centerline of an object and the direction of comparison may be in a radial or lateral direction.

As used herein, “front” may indicate the side of an object that is closest to a forward direction of travel under normal use of the object or the side or part of an object that normally presents itself to view or that is normally used first. “Rear” or “back” may refer to the side that is opposite the front.

As used in this disclosure, a “hinge” may be a device that permits the turning, rotating, or pivoting of a first object relative to a second object.

As used in this disclosure, “horizontal” may be a directional term that refers to a direction that is perpendicular to the local force of gravity. Unless specifically noted in this disclosure, the horizontal direction is always perpendicular to the vertical direction.

As used in this disclosure, the term “intermediate” may refer to a location that lies between a first object and a second object

As used in this disclosure, the word “lateral” may refer to the sides of an object or movement towards a side. Lateral directions are generally perpendicular to longitudinal directions. “Laterally” may refer to movement in a lateral direction.

As used in this disclosure, “orientation” may refer to the positioning and/or angular alignment of a first object relative to a second object or relative to a reference position or reference direction.

As used herein, the word “pivot” may include any mechanical arrangement that allows for rotational motion. Non-limiting examples of pivots may include hinges, holes, posts, dowels, pins, points, rods, shafts, balls, and sockets, either individually or in combination.

As used in this disclosure, “vertical” may refer to a direction that is parallel to the local force of gravity. Unless specifically noted in this disclosure, the vertical direction is always perpendicular to horizontal.

With respect to the above description, it is to be realized that the optimum dimensional relationship for the various components of the invention described above and in FIGS. 1 through 4, include variations in size, materials, shape, form, function, and manner of operation, assembly and use, are deemed readily apparent and obvious to one skilled in the art, and all equivalent relationships to those illustrated in the drawings and described in the specification are intended to be encompassed by the invention.

It shall be noted that those skilled in the art will readily recognize numerous adaptations and modifications which can be made to the various embodiments of the present invention which will result in an improved invention, yet all of which will fall within the spirit and scope of the present invention as defined in the following claims. Accordingly, the invention is to be limited only by the scope of the following claims and their equivalents.

The inventor claims:

1. A compound miter saw table comprising:
a workshop table, a left side wing, and a right side wing;
wherein the workshop table is configured to support a saw;
wherein the left side wing and the right side wing are deployed individually or together in order to support a work material while the work material is being cut;
wherein a top surface of the workshop table is recessed below top surfaces of the left side wing and the right side wing such that the work material rests evenly, supported by the saw, the left side wing, the right side wing, or any combination thereof;
wherein the workshop table comprises a table top, a plurality of lens, a bottom shelf, one or more intermediate shelves, and a plurality of wheels;
wherein the table top is a horizontal planar surface which supports the saw;
wherein the table top comprises a left offset block coupled to the center left side of the top surface of the table top and a right offset block coupled to the center right side of the top surface of the table top;
wherein the bottom shelf is a horizontal planar surface coupled to the plurality of leas at the bottom of the workshop table;
wherein the bottom shelf provides storage area for tools and/or materials;
wherein the bottom shelf extends laterally to the outside surfaces of the plurality of less;
wherein the bottom shelf comprises a left stopper block coupled to the center left side of the top surface of the bottom shelf and a right stopper block coupled to the center right side of the top surface of the bottom shelf.

2. (canceled)

3. The compound miter saw table according to claim 1
wherein the left side wing hingedly couples to the left offset block;
wherein the right side wing hingedly couples to the right offset block.

4. The compound miter saw table according to claim 3
wherein the table top is supported by the plurality of legs;
wherein the plurality of legs are vertically oriented and located at each corner of the workshop table;
wherein the table top couples to the tops of the plurality of legs;
wherein the table top extends to the outside surfaces of the plurality of legs both laterally and front-to-rear.

5. (canceled)

6. (canceled)

7. The compound miter saw table according to claim 4
wherein the left stopper block retains the bottom end of the left side wing when the left side wing is deployed;
wherein the right stopper block retains the bottom end of the right side wing when the right side wing is deployed.

8. The compound miter saw table according to claim 7
wherein the one or more intermediate shelves are horizontal planar surfaces coupled to the plurality of legs at heights between the table top and the bottom shelf;
wherein the one or more intermediate shelves provide storage area for tools and/or materials.

9. The compound miter saw table according to claim 8
wherein the one or more intermediate shelves extend laterally to the inside surfaces of the plurality of legs.

10. The compound miter saw table according to claim 9
wherein the plurality of wheels reduce friction between the workshop table and the ground such that the workshop table is movable between job sites;
wherein the plurality of wheels are coupled to the bottom of the workshop table.

11. The compound miter saw table according to claim 10
wherein two or more of the plurality of wheels swivel to facilitate steering.

12. The compound miter saw table according to claim 10
wherein two or more of the plurality of wheels comprise brakes to prevent the workshop table from moving during use.

13. The compound miter saw table according to claim 10
wherein an individual side wing selected from the left side wing and the right side wing is an articulated extension that supports the work material when the individual side wing is deployed and folds against a side of the workshop table when the individual side wing is not deployed;
wherein the individual side wing comprises a horizontal armature and a diagonal armature;
wherein when the individual side wing is deployed, the horizontal armature extends horizontally to support the work material and the diagonal armature braces the horizontal armature against the bottom shelf.

14. The compound miter saw table according to claim 13
wherein the proximal end of the horizontal armature is hingedly coupled to an individual offset block selected from the left offset block and the right offset block;
wherein when the individual side wing is deployed, the horizontal armature covers the top of the individual offset block;
wherein the horizontal armature is coupled to the individual offset block via a first wing hinge;
wherein the first wing hinge is positioned where the top outside edge of the individual offset block meets the underside of the horizontal armature such that the horizontal armature rests on top of the individual offset block when the individual side wing is deployed and pivots to a position alongside the individual offset block when the individual side wing is not deployed.

15. The compound miter saw table according to claim 14
wherein the top of the diagonal armature is hingedly coupled to the distal end of the horizontal armature via a second wing hinge;
wherein the second wing hinge is positioned on the underside of the distal end of the horizontal armature;
wherein the second wing hinge enables the diagonal armature to pivot to a position that is adjacent to the underside of the horizontal armature.

16. The compound miter saw table according to claim 15
wherein when the individual side wing is deployed, the diagonal armature extends from the distal end of the horizontal armature to an individual stopper block selected from the left stopper block and the right stopper block such that the diagonal armature supports the distal end of the horizontal armature as a brace.

17. The compound miter saw table according to claim 16
wherein the diagonal armature comprises an upper diagonal armature and a lower diagonal armature;
wherein the upper diagonal armature and the lower diagonal armature are hingedly coupled via a third wing hinge such that the diagonal armature folds when the individual side wing is not deployed;
wherein the third wing hinge is positioned on the underside of the diagonal armature where the upper diagonal armature and the lower diagonal armature meet.

18. The compound miter saw table according to claim 17
wherein the bottom end of the lower diagonal armature is mitered to match the angle that the diagonal armature meets the individual stopper block.

19. The compound miter saw table according to claim 18
wherein the individual side wing is deployed by pivoting the horizontal armature to a horizontal orientation, unfolding the diagonal armature, and positioning the bottom end of the diagonal armature against the individual stopper block;
wherein the individual side wing is stored by folding the diagonal armature at the third wing hinge, pivoting the diagonal armature up to a position adjacent to the horizontal armature, and pivoting the horizontal armature to a vertical orientation.

20. The compound miter saw table according to claim 19
wherein when the individual side wing is not deployed, the diagonal armature remains folded and is located in the space between the one or more intermediate shelves and the horizontal armature which is vertically oriented.
